(19) United States
(12) Patent Application Publication
(10) Pub. No.: US 2026/0361593 A1
(43) Pub. Date: Nov. 12, 2026

(54) ENHANCED COORDINATED SERVICE RECOVERY IN WIRELESS NETWORK

(71) Applicant: Samsung Electronics Co., Ltd., Gyeonggi-do (KR)

(72) Inventors: Ashutosh KAUSHIK, Bangalore (IN); Deepanshu GAUTAM, Bangalore (IN); Erik GUTTMAN, Staines (GB)

(21) Appl. No.: 19/126,428

(22) PCT Filed: Nov. 2, 2023
(86) PCT No.: PCT/KR2023/017401

§ 371 Date: May 1, 2025

(30) Foreign Application Priority Data
Nov. 2, 2022 (IN) 202241062710
Oct. 13, 2023 (IN) 202241062710

(51) Int. Cl. H04L 41/0654; H04W 24/04; H04W 88/08

(52) U.S. Cl. CPC H04L 41/0654; H04W 24/04; H04W 88/08

(57) ABSTRACT

The disclosure relates to a 5G or 6G communication system for supporting a higher data transmission rate. A method performed by a first server in a mobile communication system, the method comprising: performing, with a second server, a create managed object instance (MOI) procedure for a first information object class (IOC) associated with recovery of an energy service; and creating a first MOI associated with uninterruptable power supply (UPS) related information of the first server, based on the create MOI procedure, wherein the UPS related information of the first server is included in the first IOC.

### TECHNICAL FIELD

The embodiments disclosed herein generally relate to field of network performance management for third parties, and more particularly related to a method and a wireless network for enhancing coordinated service recovery in the wireless network.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

In general, an energy utility provider as Distribution System Operator (DSO) is a natural or a legal person for operating, and ensuring maintenance of power distribution and developing a distribution system in a given area. The distribution system provides interconnections with other systems, and for ensuring the long-term ability of the system to meet reasonable demands for the distribution of electricity. A delivery of electrical energy must occur with extreme levels of availability. Regulatory, business and public health and safety requirements are most important. In order to achieve the reliable availability, a range of ‘smart energy services’ are employed by an energy system. As greater degrees of efficiency, resiliency, responsiveness and other capabilities are sought in the generation and delivery of electricity, more and more communications services are required by the electrical energy sector. To the extent that the Third Generation Partnership Project (3GPP) communication system can provide services that meet the needs of an electrical energy sector, telecommunications are increasingly important part of the technical ecosystem by which electricity is delivered.

In general, energy service outage at the medium voltage energy distribution system occurs. A ‘switch ON and OFF’ process is pursued to secure energy distribution through the redundant distribution cabling system by establishing a stable and sufficient topology. The process is very slow if done manually and very fast if the process is done through smart energy control. If the energy service to critical communication infrastructure (e.g., base stations or data centers) is shut down for too long that results in Mobile Network Operator (MNO) site's Uninterruptible Power Supply (UPS) power exhaustion then remote ‘smart energy’ procedures for rapid recovery are impossible. For instance, note that in one city there could be around 100,000 such medium energy substations that are interconnected by means of redundant cables. There are outages that are either through failure incidents (due to severed cables, etc.) or through planned maintenance that occur every week throughout the infrastructure, so this is not a rare event. Only way to restore service is to iterate through a range of possible re-configurations of the redundant cablings fabric. This will successively produce ‘energy service outages’ to some specific customers. The choice and timing strategy of the selective reconfigurations, producing transient energy service outages for customers, is fully under control of the DSO, and can be done very effectively using smart energy services such as distribution automation.

Further, a DSO station may unknowingly create outages in MNO sites that are crucial for the infrastructure during process of energy outage recovery. But if the information like UPS backup status at MNO sites′, base station identifiers (IDs) that are mapped to meter ids, battery draining status at the MNO site etc., is known to the DSO station, then the DSO station may work more intelligently on the energy outage recovery, taking into account which base station Ids of MNO their infrastructure relies on as well as the UPS backup remaining life in that the MNO site.

Currently disaster recovery plans are ‘static’ and data exchanged is not standards based. There is no standardized mechanism to share all the information between the DSO station and the MNO device to enable fully optimal planned outages by the DSO station. The optimal planned outages during the recovery processes protect intended MNO sites/facilities from service outages that have insufficient UPS backup or do not have it at all or to protect critical MNO facilities like data-centers from service outages or to protect such MNO sites from outages that provide rapid intervention support (of communication services) to the DSO station for pursuing latter's smart energy service procedures for rapid recovery of energy outage.

The above information is presented as background information only to help the reader to understand the present invention. Applicants have made no determination and make no assertion as to whether any of the above might be applicable as prior art with regard to the present application.

### DISCLOSURE OF INVENTION

### Solution to Problem

A method performed by a first server in a mobile communication system, the method comprising: performing, with a second server, a create managed object instance (MOI) procedure for a first information object class (IOC) associated with recovery of an energy service; and creating a first MOI associated with uninterruptable power supply (UPS) related information of the first server, based on the create MOI procedure, wherein the UPS related information of the first server is included in the first IOC.

A first server in a mobile communication system, the first server comprising: a transceiver; and a controller coupled with the transceiver and configured to: perform, with a second server, a create managed object instance (MOI) procedure for a first information object class (IOC) associated with recovery of an energy service, and create a first MOI associated with uninterruptable power supply (UPS) related information of the first server, based on the create MOI procedure, wherein the UPS related information of the first server is included in the first IOC.

A method performed by a second server in a mobile communication system, the method comprising: performing, with a first server, a create managed object instance (MOI) procedure for a first information object class (IOC) associated with recovery of an energy service, wherein a first MOI associated with uninterruptable power supply (UPS) related information of the first server is created based on the create MOI procedure, and wherein the UPS related information of the first server is included in the first IOC.

A second server in a mobile communication system, the second server comprising: a transceiver; and a controller coupled with the transceiver and configured to: perform, with a first server, a create managed object instance (MOI) procedure for a first information object class (IOC) associated with recovery of an energy service, wherein a first MOI associated with uninterruptable power supply (UPS) related information of the first server is created based on the create MOI procedure, and wherein the UPS related information of the first server is included in the first IOC.

### BRIEF DESCRIPTION OF DRAWINGS

This invention is illustrated in the accompanying drawings, throughout which like reference letters indicate corresponding parts in the various figures. The embodiments herein will be better understood from the following description with reference to the drawings, in which:

FIG. 1 illustrates a sequence diagram illustrating a method for enhancing coordinated service recovery in a wireless network, according to the embodiments disclosed herein;

FIG. 2 an example illustration for enhancing coordinated service recovery in network management for MnoUpsInfo Information Object Class, according to the embodiments as disclosed herein;

FIG. 3 is an example illustration depicting inheritance of DsoRapidRecovery IOC and MnoUpsInfo IOC, according to the embodiments as disclosed herein;

FIG. 4 shows various hardware components of a MNO device, according to the embodiments as disclosed herein;

FIG. 5 shows various hardware components of a DSO station, according to the embodiments as disclosed herein;

FIG. 6 is a flow chart illustrating a method, implemented by the MNO device, for the enhanced coordinated service recovery in the wireless network, according to the embodiments as disclosed herein; and

FIG. 7 is a flow chart illustrating a method, implemented by the DSO station, for the enhanced coordinated service recovery in the wireless network, according to the embodiments as disclosed herein.

FIG. 8 illustrates a structure of a UE according to an embodiment of the disclosure.

FIG. 9 illustrates a structure of a base station according to an embodiment of the disclosure.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the invention. Furthermore, the one or more elements may have been represented in the drawing by conventional symbols, and the drawings may show only those specific details that are pertinent to the understanding the embodiments of the invention so as not to obscure the drawing with details that will be readily apparent to those of ordinary skill in the art having benefit of the description herein.

### MODE FOR THE INVENTION

The principal object of the embodiments herein is to perform a method and a wireless network for enhanced coordinated service recovery in the wireless network.

Another object of the embodiments herein is to enable mutual exchange of UPS backup related information between a third party energy utility (i.e., DSO station) and a MNO device by using standardized interfaces exposed by a 3GPP network management system to achieve coordinated intelligent outage planning by the DSO station during its energy service outage recovery.

Another object of the embodiments herein is to provide a standardized mechanism for the DSO station to query and get up to date UPS backup information of targeted critical infrastructure and base stations in the MNO infrastructure, so that the DSO station can pursue rapid recovery procedures more intelligently i.e. enhanced coordinated service recovery with the help of the MNO device.

Another object of the embodiments herein is to provide that, during its service outage recovery process, the DSO station can avoid interrupting energy service for base station IDs that their UEs camp on or for critical infrastructures like MNO's data centers in order to avoid communication service outage for its own automated smart energy service procedures.

Yet, another object of the embodiments herein is to provide that energy service interruptions can however potentially be created by the DSO station as long as there is UPS capacity remaining for the duration of the outage at the site and the DSO station tactically use the remaining time as best it can, ordering their outages and keeping them short.

Yet, another object of the embodiments herein is to provide that the MNO device can also enable “limited” or “controlled” usage of its UPS backup for sites that are candidates to provide MNO device rapid intervention i.e. dedicated communication services to the DSO station for their rapid recovery of energy distribution service outage.

Yet, another object of the embodiments herein is to provide that the DSO station can plan very intelligently an optimal energy service outage strategy for the MNO device that facilities keeping intact its own interests of rapid recovery and MNO's interest of communication service continuity.

Yet, another object of the embodiments herein is to provide that the MNO device benefits from less electrical energy outages, reduced battery bank usage and much reduced chances of UPS backup exhaustion resulting in lesser communication services outages because of the DSO station supplied energy outage.

Embodiments disclosed herein provide a method for enhanced coordinated service recovery in a wireless network. The method includes receiving, by a MNO device, a create MOI request from the DSO station. The create MOI request is for creating an IOC representing UPS related information of a MNO site as child of an IOC for DSO rapid recovery. Further, the method includes creating, by the MNO device, the IOC representing the UPS related information of a MNO site including a plurality of attributes. The IOC representing the UPS related information of the MNO site is created as child of the IOC for the DSO rapid recovery. Further, the method includes sending, by the MNO device, a create MOI response to the DSO station after creation of the IOC representing the UPS related information of the MNO site.

In an embodiment, the plurality of attributes of the IOC representing the UPS related information of the MNO site includes information about whether the MNO site has a UPS installed/available or not, information about a total UPS backup capacity installed in the MNO site, information about a status of remaining UPS backup capacity available for the MNO site at a given time, an identity of an energy supply meter of the DSO present in the MNO site, and an identity of a base station present in the MNO site.

In an embodiment, further, the method includes receiving, by the MNO device, a create MOI request from the DSO station for creating a notification subscription control IOC to the MNO device. The create MOI request includes a plurality of notification subscription parameters related to the IOC representing the UPS related information of the MNO site. Further, the method includes creating, by the MNO device, the notification subscription control IOC based on the plurality of notification subscription parameters. Further, the method includes sending, by the MNO device, a create MOI response to the DSO station after creation of the notification subscription control IOC by the MNO device.

In an embodiment, further, the method includes detecting, by the MNO device, change in at least one attribute of the plurality of parameters of the IOC representing the UPS related information of the MNO site. Further, the method includes modifying, by the MNO device, the at least one attribute of the IOC representing the UPS related information based on the detected change. Further, the method includes sending, by the MNO device, a notification to the DSO station informing about the changes to the at least one modified attribute of the IOC representing the UPS related information of MNO site based on the notification subscription control IOC.

In an embodiment, the plurality of notification subscription parameters includes at least one of a notification recipient address attribute having an address of the DSO station, an notification types attribute having a notify MOI attribute value changes to at least one attribute of the plurality of attributes of the IOC representing the UPS related information of MNO site, and an attribute notification filter indicating a filter to be applied to candidate notifications identified by the notification types attribute.

In an embodiment, further, the method includes receiving, by the MNO device, a get MOI attribute request from the DSO station to retrieve at least one attribute of the plurality of attributes of the IOC representing the UPS related information of MNO site. Further, the method includes sending, by the MNO device, a get MOI attribute response including the at least one attribute of the IOC representing the UPS related information of MNO site to the DSO station.

Embodiments disclosed herein provide a method for coordinated service recovery in a wireless network. The method includes sending, by a DSO station, a create MOI request to a MNO device for creating an IOC representing UPS related information of MNO site as child of an IOC for a DSO rapid recovery. Further, the method includes receiving, by the DSO station, a create MOI response from the MNO device after creation of the IOC representing the UPS related information of a MNO site including a plurality of attributes. The IOC representing the UPS related information of the MNO site is created as child of the IOC for the DSO rapid recovery. Further, the method includes performing, by the DSO station, coordinated intelligent outage planning using the IOC representing the UPS related information of MNO site.

In an embodiment, further, the method includes creating, by the DSO station, a create MOI request including a plurality of notification subscription parameters for the DSO station. The plurality of notification subscription parameters includes at least one of a notification recipient address attribute having an address of the DSO station, an notification types attribute having a notify MOI attribute value changes to at least one attribute of the plurality of attributes of the IOC representing the UPS related information of MNO site, and an attribute notification filter indicating a filter to be applied to candidate notifications identified by the notification types attribute. Further, the method includes sending, by the DSO station, the create MOI request to the MNO device for creating a notification subscription control IOC as per the plurality of notification subscription parameters. Further, the method includes receiving, by the DSO station, a create MOI response from the MNO device after creation of the notification subscription control IOC by the MNO device.

In an embodiment, further, the method includes receiving, by the DSO station, a notification from the MNO device informing about changes to at least one modified attribute of the plurality of attributes of the IOC representing the UPS related information of MNO site based on the notification subscription control IOC.

In an embodiment, further, the method includes sending, by the DSO station, a get MOI attribute request to the MNO device to retrieve at least one attribute of the plurality of attributes of the IOC representing the UPS related information of MNO site from the MNO device. Further, the method includes receiving, by the DSO station, a get MOI attribute response including the at least one attribute of the IOC representing the UPS related information of MNO site from the MNO device.

Embodiments disclosed herein provide a MNO device for coordinated service recovery in a wireless network. The MNO device includes a coordinated service recovery controller communicatively coupled to a memory and a processor. The coordinated service recovery controller is configured to receive a create MOI request from the DSO station. The create MOI request is for creating an IOC representing UPS related information of a MNO site as child of an IOC for DSO rapid recovery. Further, the coordinated service recovery controller is configured to create the IOC representing the UPS related information of a MNO site including a plurality of attributes, where the IOC representing the UPS related information of the MNO site is created as child of the IOC for the DSO rapid recovery. Further, the coordinated service recovery controller is configured to send a create MOI response to the DSO station after creation of the IOC representing the UPS related information of the MNO site.

Embodiments disclosed herein provide a DSO station for coordinated service recovery in a wireless network. The DSO station includes a coordinated service recovery controller communicatively coupled to a memory and a processor. The coordinated service recovery controller is configured to send a create MOI request to a MNO device for creating an IOC representing UPS related information of MNO site as child of an IOC for a DSO rapid recovery. The coordinated service recovery controller is configured to receive a create MOI response from the MNO device after creation of the IOC representing the UPS related information of a MNO site including a plurality of attributes, where the IOC representing the UPS related information of the MNO site is created as child of the IOC for the DSO rapid recovery. Further, the coordinated service recovery controller is configured to perform coordinated intelligent outage planning using the IOC representing the UPS related information of MNO site.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

Various embodiments of the present disclosure will now be described in detail with reference to the accompanying drawings. In the following description, specific details such as detailed configuration and components are merely provided to assist the overall understanding of these embodiments of the present disclosure. Therefore, it should be apparent to those skilled in the art that various changes and modifications of the embodiments described herein can be made without departing from the scope and spirit of the present disclosure. In addition, descriptions of well-known functions and constructions are omitted for clarity and conciseness.

Also, the various embodiments described herein are not necessarily mutually exclusive, as some embodiments can be combined with one or more other embodiments to form new embodiments.

Herein, the term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the invention. Likewise, the blocks of the embodiments may be physically combined into more complex blocks without departing from the scope of the invention

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Embodiments disclosed herein provide a method for enhanced coordinated service recovery in a wireless network. The method includes receiving, by a MNO device, a create MOI request from the DSO station. The create MOI request is for creating an IOC representing UPS related information of a MNO site as child of an IOC for DSO rapid recovery. Further, the method includes creating, by the MNO device, the IOC representing the UPS related information of a MNO site including a plurality of attributes. The IOC representing the UPS related information of the MNO site is created as child of the IOC for the DSO rapid recovery. Further, the method includes sending, by the MNO device, a create MOI response to the DSO station after creation of the IOC representing the UPS related information of the MNO site.

The proposed method involves mutual exchange of information for mutual benefits between a third party energy utility (i.e., DSO station) and the MNO using standardized interfaces exposed by the 3GPP network management system for timely recovery of utility's energy service outage. The proposed method can be used to protect the MNO sites from complete break-down in case of UPS running out of its capacity due to prolonged DSO energy service outage. The DSO station avoids shutting down of energy service for base station IDs that the UEs camp on or the critical MNO infrastructure with insufficient UPS backup capacity to ‘survive’ the planned outage or alternatively the energy service interruptions are potentially created by the DSO station as long as there is sufficient UPS backup capacity remaining for the duration of the outage at the MNO site.

Further, the DSO station gathers the meter identities and base station identities information from the MNO, the UPS backup remaining life in the MNO base stations. The MNO knows the base station identities and corresponding meter identities, the uninterruptable power supply resources, the current status of UPS backup at sites, battery draining status etc. The MNO can also enable “limited” or “controlled” usage of its UPS backup for sites that are candidates to provide MNO rapid intervention i.e. dedicated communication services to DSO station for the rapid recovery of energy distribution service outage. The proposed method can be used to provide a standardized mechanism for the DSO station to query and receive latest updated UPS backup information of targeted critical infrastructure and base stations in the MNO infrastructure, so that the DSO station can pursue rapid recovery procedures more intelligently i.e. enhanced coordinated service recovery with the help of MNO device.

Based on the proposed methods, by using a Network Resource Model (NRM) based approach, the provisioning MnS (Management Service) and related NRM fragments are used with novel IOC and configurations defined as part of the proposed patent disclosure. The DSO station uses MnoUpsInfo IOC to configure the required MNO information for DSO's energy service outage recovery like, UPS remaining backup status at MNO site, base station Ids providing services to DSO UEs, meter Ids corresponding to base station Ids etc. The DSO station uses the NtfSubscriptionControl IOC to subscribe for notifyMOIAttribute ValueChanges notifications in order to get notified about the change in information which MNO configures. The DSO station can also use getMOIAttribute to query the UPS related information for a particular base station or the meter Id.

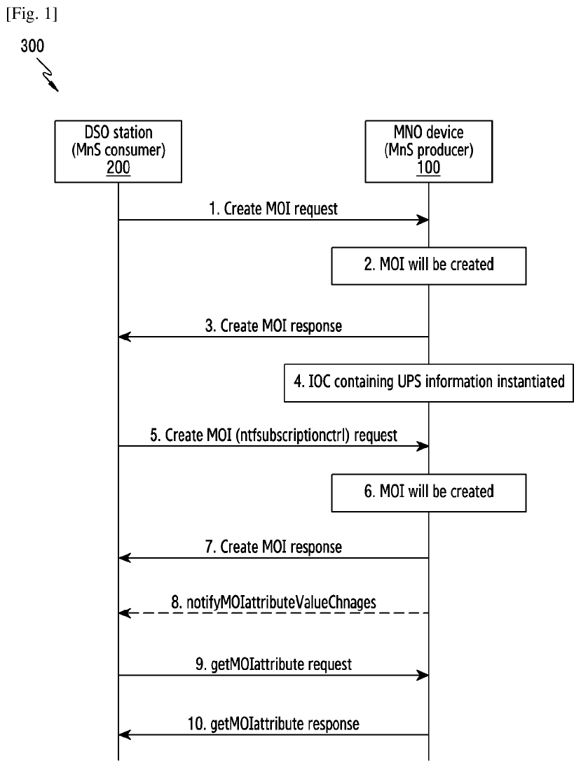

Referring now to the drawings, and more particularly to FIGS. 1 through 7, there are shown preferred embodiments.

FIG. 1 illustrates a sequence diagram illustrating a method for enhancing coordinated service recovery in a wireless network (1000), according to the embodiments disclosed herein. In an embodiment, the wireless network (1000) includes a MNO device (100) and a DOS station (200). The wireless network (1000) can be, for example, but not limited to a fourth generation (4G) network, a fifth generation (5G) network, an Open Radio Access Network (ORAN) or the like. The DOS station (200) can be a management service (MnS) consumer and the MNO device (100) can be a management service (MnS) producer.

At step 1, the DSO station (200) sends a create MOI request to the MNO device (100) for creating an IOC representing UPS related information of a MNO site as child of an IOC for a DSO rapid recovery. At step 2, the MNO device (100) creates the MOI. At step 3, the MNO device (100) sends a create MOI response to the DSO station (200) after creation of the IOC representing the UPS related information of the MNO site comprising the plurality of attributes. The plurality of attributes of the IOC of the UPS related information of MNO site includes information about whether the MNO site has the UPS installed/available or not, information about a total UPS backup capacity installed in the MNO site, information about a status of remaining UPS backup capacity available for MNO site at a given time, an identity of an energy supply meter of the DSO present in the MNO site, and an identity of a base station present in the MNO site. At step 4, the IOC representing the UPS related information of the MNO site is created as child of the IOC for the DSO rapid recovery. Further, the DSO station (200) performs the coordinated intelligent outage planning using the IOC representing the UPS related information of MNO site.

Further, the DSO station (200) creates a create MOI request including a plurality of notification subscription parameters. The plurality of notification subscription parameters includes a notification recipient address attribute having the address of the DSO station (200), an notification types attribute having a notify MOI attribute value changes to the attribute of the plurality of attributes of the IOC representing the UPS related information of the MNO site, and an attribute notification filter indicating a filter to be applied to candidate notifications identified by the notification types attribute. At step 5, the DSO station (200) sends the create MOI request (i.e., Create MOI (ntfsubscriptionctrl) request) to the MNO device (100) for creating a notification subscription control IOC as per the plurality of notification subscription parameters. At step 6, the MOI will be created at the MNO device (100). At step 7, the DSO station (200) receives a create MOI response from the MNO device (100) after creation of the notification subscription control IOC by the MNO device (100).

In an embodiment, at step 8, the DSO station (200) receives a notification from the MNO device informing about changes to at least one modified attribute of the plurality of attributes of the IOC representing the UPS related information of MNO site based on the notification subscription control IOC.

At step 9, the DSO station (200) sends a get MOI attribute request to the MNO device (100) to retrieve the attribute of the plurality of attributes of the IOC representing the UPS related information of the MNO site from the MNO device (100). At step 10, the DSO station (200) receives a get MOI attribute response including the attribute of the IOC representing the UPS related information of MNO site from the MNO device (100).

In other words, a CreateMOI (Managed Object Instance) procedure is for creating DsoRapidRecovery IOC (Information Object Class) as parent IOC and MnoUpsInfo IOC as its child IOC. The DsoRapidRecovery IOC is already explained the patent application number “202241060835” titled: “COORDINATED SERVICE RECOVERY IN WIRELESS NETWORK”.

The MNO device (100) creates the MOI of MnoUpsInfo IOC representing the UPS related info of MNO site as child IOC of DsoRapidRecovery IOC. The DSO station (200) sends createMOI for NtfSubscriptionControl IOC to the MNO device (100) which contains following attributes. The attribute notificationRecipientAddress contains the address of the notification recipient i.e. DSO station (200). The attribute notificationTypes contains the notification notifyMOIAttribute ValueChanges. This is forwarded to the DSO station (200). The attribute notificationFilter indicates the Filter to be applied to candidate notifications identified by the notificationTypes attribute. Only notifications that pass the filter criteria are forwarded to the notification recipient. The createMOI response is sent by MNO MnS producer to the DSO station (200). The DSO station (200) can query the UPS related information as and when required by using the getMOIAttributes operation. The attribute attributeListIn of the request will list all the required attributes (e.g. remainingUpsBackupDuration). The filter attribute will provide filtration based on meterId or baseStationId (e.g. meterId=M1 will provide the required information related to M1). The DSO station (200) provides the required information in the response.

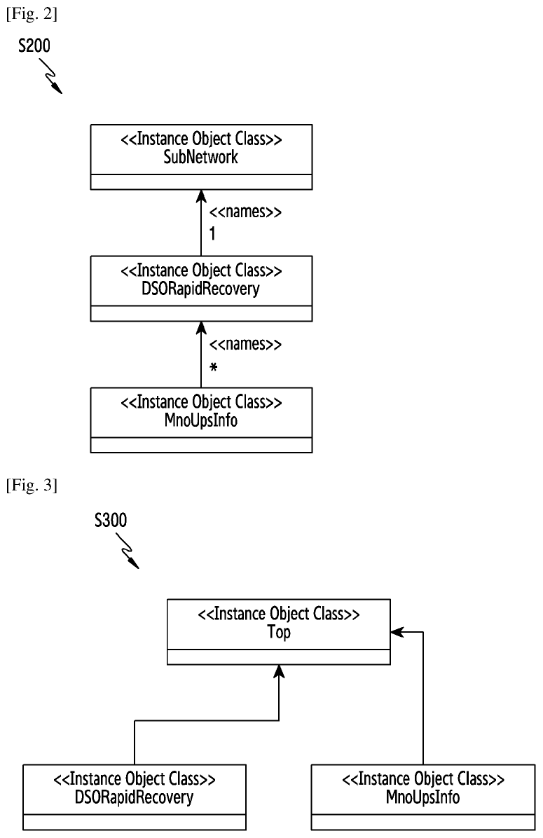

FIG. 2 an example illustration (S200) for enhancing coordinated service recovery in network management for MnoUpsInfo Information Object Class, according to the embodiments as disclosed herein. Referring to FIG. 2, the DsoRapidRecovery IOC will be name contained in a SubNetwork IOC. The DsoRapidRecovery IOC is already explained the patent application number “202241060835” titled: “COORDINATED SERVICE RECOVERY IN WIRELESS NETWORK”. One SubNetwork IOC will relate to only one instance of DsoRapidRecovery IOC. The MnoUpsInfo IOC will be name contained in DsoRapidRecovery IOC. One DsoRapidRecovery IOC will relate to multiple MnoUpsInfo IOC providing MNO's UPS information for a particular site or a base station.

FIG. 3 is an example illustration (S300) depicting inheritance of DsoRapidRecovery IOC and MnoUpsInfo IOC, according to the embodiments as disclosed herein. Both DsoRapidRecovery IOC and MnoUpsInfo IOC will inherit from Top IOC. The MnoUpsInfo IOC represents the UPS related information of MNO site or the base station. It is name-contained by DsoRapidRecovery IOC. The DsoRapidRecovery IOC is already explained the patent application number “202241060835” titled: “COORDINATED SERVICE RECOVERY IN WIRELESS NETWORK”. This is required by the DSO station (200) from MNO device (100) to achieve coordinated intelligent outage planning by the DSO station (200) during its energy outage recovery. It contains following attributes:
1. The attribute isUpsAvailable tells if the MNO site has UPS installed/available or not.
2. The attribute totalUpsBackupDuration defines the total UPS backup capacity installed in MNO site in minutes i.e. the MNO site UPS backup can exist for how many minutes.
3. The attribute remainingUpsBackupDuration defines the remaining UPS backup capacity in minutes available for MNO site at any given time.
4. The attribute meterId gives the identity of DSO meter present in MNO site.
5. The attribute baseStationId gives the identity of base station present in MNO site.

The name of attributes are shown below table 1:

TABLE 1

| | Support | isRead- | isWrit- | isIn- | isNoti- |
|---|---|---|---|---|---|
| Attribute name | Qualifier | able | able | variant | fyable |
| administrativeState | M | T | T | F | T |
| operationalState | M | T | F | F | T |
| isUpsAvailable | M | T | T | F | T |
| totalUpsBack- | M | T | T | F | T |
| upDuration | | | | | |
| remainingUpsBack- | M | T | T | F | T |
| upDuration | | | | | |
| meterId | M | T | T | F | T |
| baseStationId | M | T | T | F | T |

The following table 2 defines the properties of attributes specified in the present invention.

TABLE 2

| | Documentation and | |
|---|---|---|
| Attribute Name | Allowed Values | Properties |
| isUpsAvailable | It tells if the MNO site has | type: Boolean |
| | UPS installed/available or | multiplicity: 1 |
| | not. There might be some | isOrdered: N/A |
| | sites where UPS is not | isUnique: N/A |
| | installed yet or is under | defaultValue: |
| | progress etc. | None |
| | Its value can be True or | isNullable: |
| | False. | False |
| totalUpsBackupDuration | Total time duration for which | type: Integer |
| | MNO site can operate on its | multiplicity: 1 |
| | UPS backup i.e. capacity of | isOrdered: N/A |
| | UPS backup in terms of time | isUnique: N/A |
| | duration (e.g. minutes) for | defaultValue: |
| | which it can provide power | None |
| | supply to MNO site from | isNullable: |
| | onset of DSO outage. | False |
| | It is defined in minutes. | |
| | allowedValues: Integer with | |
| | a minimum value of 1 | |
| remainingUpsBack- | Remaining Time duration for | type: Integer |
| upDuration | which MNO site can operate | multiplicity: 1 |
| | on its UPS backup at a given | isOrdered: N/A |
| | time i.e. capacity of UPS | isUnique: N/A |
| | backup in terms of time | defaultValue: |
| | duration (e.g. minutes) for | None |
| | which it can provide power | isNullable: |
| | supply to MNO site from a | False |
| | given time. | |
| | It is defined in minutes. | |
| | allowedValues: Integer with | |
| | a minimum value of 1 | |
| meterId | Every base station will have a | type: String |
| | meter installed by DSO with | multiplicity: 1 |
| | a unique meterId that is | isOrdered: N/A |
| | visible/known to DSO. | isUnique: N/A |
| | | defaultValue: |
| | | None |
| | | isNullable: |
| | | False |
| baseStationId | Base station identity as | type: String |
| | defined by MNO for its base | multiplicity: 1 |
| | stations in a given site | isOrdered: N/A |
| | | isUnique: N/A |
| | | defaultValue: |
| | | None |
| | | isNullable: |
| | | False |

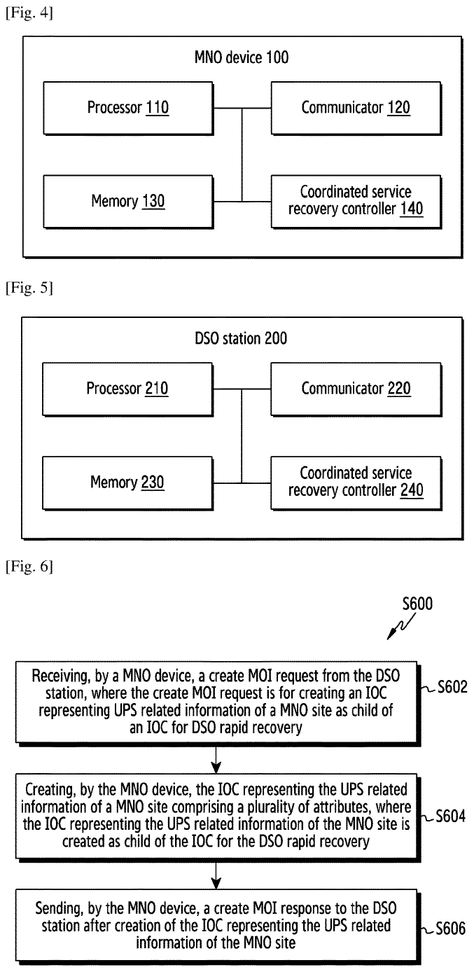

FIG. 4 shows various hardware components of the MNO device (100), according to the embodiments as disclosed herein. In an embodiment, the MNO device (100) includes a processor (110), a communicator (120), a memory (130) and a coordinated service recovery controller (140). The processor (110) is coupled with the communicator (120), the memory (130) and the coordinated service recovery controller (140).

The coordinated service recovery controller (140) receive the create MOI request from the DSO station (200). The create MOI request is for creating an IOC representing UPS related information of the MNO site as child of the IOC for DSO rapid recovery. Further, the coordinated service recovery controller (140) creates the IOC representing the UPS related information of a MNO site including the plurality of attributes. The plurality of attributes of the IOC representing the UPS related information of the MNO site includes information about whether the MNO site has a UPS installed/available or not, information about a total UPS backup capacity installed in the MNO site, information about a status of remaining UPS backup capacity available for the MNO site at a given time, an identity of an energy supply meter of the DSO present in the MNO site, and an identity of a base station present in the MNO site. The IOC representing the UPS related information of the MNO site is created as child of the IOC for the DSO rapid recovery. Further, the coordinated service recovery controller (140) sends a create MOI response to the DSO station (200) after creation of the IOC representing the UPS related information of the MNO site.

Further, the coordinated service recovery controller (140) receives the create MOI request from the DSO station (200) for creating a notification subscription control IOC to the MNO device (100). The create MOI request includes a plurality of notification subscription parameters related to the IOC representing the UPS related information of the MNO site. The plurality of notification subscription parameters includes a notification recipient address attribute having an address of the DSO station (200), an notification types attribute having a notify MOI attribute value changes to the attribute of the plurality of attributes of the IOC representing the UPS related information of MNO site, and an attribute notification filter indicating a filter to be applied to candidate notifications identified by the notification types attribute. Further, the coordinated service recovery controller (140) creates the notification subscription control IOC based on the plurality of notification subscription parameters. Further, the coordinated service recovery controller (140) sends the create MOI response to the DSO station (200) after creation of the notification subscription control IOC by the MNO device (100).

Further, the coordinated service recovery controller (140) detects change in the attribute of the plurality of parameters of the IOC representing the UPS related information of the MNO site. Further, the coordinated service recovery controller (140) modifies the attribute of the IOC representing the UPS related information based on the detected change. Further, the coordinated service recovery controller (140) sends a notification to the DSO station (200) informing about the changes to the modified attribute of the IOC representing the UPS related information of MNO site based on the notification subscription control IOC.

Further, the coordinated service recovery controller (140) receives a get MOI attribute request from the DSO station (200) to retrieve the attribute of the plurality of attributes of the IOC representing the UPS related information of MNO site. Further, the coordinated service recovery controller (140) sends a get MOI attribute response including the attribute of the IOC representing the UPS related information of MNO site to the DSO station (200).

The coordinated service recovery controller (140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include nonvolatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Although the FIG. 4 shows various hardware components of the MNO device (100) but it is to be understood that other embodiments are not limited thereon. In other embodiments, the MNO device (100) may include less or more number of components. Further, the labels or names of the components are used only for illustrative purpose and does not limit the scope of the invention. One or more components can be combined together to perform same or substantially similar function in the MNO device (100).

FIG. 5 shows various hardware components of the DSO station (200), according to the embodiments as disclosed herein. In an embodiment, the DSO station (200) includes a processor (210), a communicator (220), a memory (230) and a coordinated service recovery controller (240). The processor (210) is coupled with the communicator (220), the memory (230) and the coordinated service recovery controller (240).

The coordinated service recovery controller (240) sends the create MOI request to the MNO device (100) for creating an IOC representing UPS related information of the MNO site as child of the IOC for the DSO rapid recovery. Further, the coordinated service recovery controller (240) receives the create MOI response from the MNO device (100) after creation of the IOC representing the UPS related information of the MNO site including the plurality of attributes. The IOC representing the UPS related information of the MNO site is created as child of the IOC for the DSO rapid recovery. Further, the coordinated service recovery controller (240) performs the coordinated intelligent outage planning using the IOC representing the UPS related information of MNO site.

Further, the coordinated service recovery controller (240) creates the create MOI request including the plurality of notification subscription parameters for the DSO station (200). The plurality of notification subscription parameters includes the notification recipient address attribute having an address of the DSO station (200), the notification types attribute having the notify MOI attribute value changes to the attribute of the plurality of attributes of the IOC representing the UPS related information of MNO site, and the attribute notification filter indicating a filter to be applied to candidate notifications identified by the notification types attribute. Further, the coordinated service recovery controller (240) sends the create MOI request to the MNO device (100) for creating the notification subscription control IOC as per the plurality of notification subscription parameters. Further, the coordinated service recovery controller (240) receives the create MOI response from the MNO device (100) after creation of the notification subscription control IOC by the MNO device (100).

Further, the coordinated service recovery controller (240) receives the notification from the MNO device (100) informing about changes to the modified attribute of the plurality of attributes of the IOC representing the UPS related information of MNO site based on the notification subscription control IOC.

Further, the coordinated service recovery controller (240) sends the get MOI attribute request to the MNO device (100) to retrieve the attribute of the plurality of attributes of the IOC representing the UPS related information of MNO site from the MNO device (100). Further, the coordinated service recovery controller (240) receive a get MOI attribute response including the attribute of the IOC representing the UPS related information of MNO site from the MNO device (100).

The coordinated service recovery controller (240) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (210) is configured to execute instructions stored in the memory (230) and to perform various processes. The communicator (220) is configured for communicating internally between internal hardware components and with external devices via one or more networks. The memory (230) also stores instructions to be executed by the processor (210). The memory (230) may include nonvolatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (230) may, in some examples, be considered a non-transitory storage medium. The term “non-transitory” may indicate that the storage medium is not embodied in a carrier wave or a propagated signal. However, the term “non-transitory” should not be interpreted that the memory (230) is non-movable. In certain examples, a non-transitory storage medium may store data that can, over time, change (e.g., in Random Access Memory (RAM) or cache).

Although the FIG. 5 shows various hardware components of the DSO station (200) but it is to be understood that other embodiments are not limited thereon. In other embodiments, the DSO station (200) may include less or more number of components. Further, the labels or names of the components are used only for illustrative purpose and does not limit the scope of the invention. One or more components can be combined together to perform same or substantially similar function in the DSO station (200).

FIG. 6 is a flow chart (600) illustrating a method, implemented by the MNO device (100), for the enhanced coordinated service recovery in the wireless network (1000), according to the embodiments as disclosed herein. The operations (S602-S606) are handled by the coordinated service recovery controller (140).

At S602, the method includes receiving the create MOI request from the DSO station (200). The create MOI request is for creating the IOC representing UPS related information of the MNO site as child of the IOC for DSO rapid recovery. At S604, the method includes creating the IOC representing the UPS related information of the MNO site including the plurality of attributes. The IOC representing the UPS related information of the MNO site is created as child of the IOC for the DSO rapid recovery. At S606, the method includes sending the create MOI response to the DSO station after creation of the IOC representing the UPS related information of the MNO site.

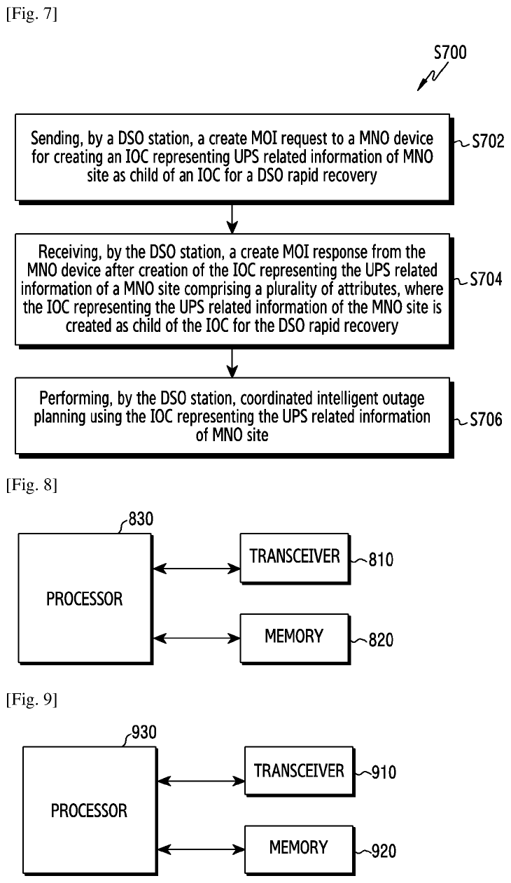

FIG. 7 is a flow chart (S700) illustrating a method, implemented by the DSO station (200), for the coordinated service recovery in the wireless network (1000), according to the embodiments as disclosed herein. The operations (S702-S706) are handled by the coordinated service recovery controller (240).

At S702, the method includes sending the create MOI request to the MNO device (100) for creating the IOC representing UPS related information of MNO site as child of an IOC for the DSO rapid recovery. At S704, the method includes receiving the create MOI response from the MNO device (100) after creation of the IOC representing the UPS related information of a MNO site including a plurality of attributes. The IOC representing the UPS related information of the MNO site is created as child of the IOC for the DSO rapid recovery. At S706, the method includes performing the coordinated intelligent outage planning using the IOC representing the UPS related information of MNO site.

The proposed method can be used to perform “limited” or “controlled” usage of its UPS backup for sites that are candidates to provide MNO rapid intervention i.e. dedicated communication services to DSO for their rapid recovery of energy distribution service outage.

The proposed method can be used to provide the standardized mechanism for the DSO station (200) to query and receive latest updated UPS backup information of targeted critical infrastructure and base stations in the MNO infrastructure, so that the DSO station (200) can pursue rapid recovery procedures more intelligently i.e. enhanced coordinated service recovery with the help of MNO. During its service outage recovery process, the DSO station (200) can avoid interrupting energy service for base station Ids that their UEs camp on or for critical infrastructures like MNO's data centers in order to avoid communication service outage for its own automated smart energy service procedures.

Energy service interruptions can however potentially be created by the DSO station (200) as long as there is UPS capacity remaining for the duration of the outage at the site and DSO station (200) tactically use the remaining time as best it can, ordering their outages and keeping them short etc. Overall, now the DSO station (200) can plan very intelligently an optimal energy service outage strategy for MNO facilities keeping intact its own interests of rapid recovery and MNO's interest of communication service continuity. The MNO device (100) benefits from less electrical energy outages, reduced battery bank usage and much reduced chances of UPS backup exhaustion resulting in lesser communication services outages because of DSO supplied energy outage. The proposed method can be used to provide mutual benefits for the DSO station (200) and the MNO device (100) through useful information sharing.

Accoring to an embodiment of the present disclosure, a method for enhanced coordinated service recovery in a wireless network (1000), comprising: receiving, by a MNO device (100), a create MOI request from the DSO station (200), wherein the create MOI request is for creating an IOC representing UPS related information of a MNO site as child of an IOC for DSO rapid recovery; creating, by the MNO device (100), the IOC representing the UPS related information of a MNO site comprising a plurality of attributes, wherein the IOC representing the UPS related information of the MNO site is created as child of the IOC for the DSO rapid recovery; and sending, by the MNO device (100), a create MOI response to the DSO station (200) after creation of the IOC representing the UPS related information of the MNO site.

Accoring to an embodiment of the present disclosure, wherein the plurality of attributes of the IOC representing the UPS related information of the MNO site comprises: information about whether the MNO site has a UPS installed/available or not, information about a total UPS backup capacity installed in the MNO site; information about a status of remaining UPS backup capacity available for the MNO site at a given time; an identity of an energy supply meter of the DSO present in the MNO site; and an identity of a base station present in the MNO site.

Accoring to an embodiment of the present disclosure, comprising: receiving, by the MNO device (100), a create MOI request from the DSO station (200) for creating a notification subscription control IOC to the MNO device (100), wherein the create MOI request comprises a plurality of notification subscription parameters related to the IOC representing the UPS related information of the MNO site; creating, by the MNO device (100), the notification subscription control IOC based on the plurality of notification subscription parameters; and sending, by the MNO device (100), a create MOI response to the DSO station (200) after creation of the notification subscription control IOC by the MNO device (100).

Accoring to an embodiment of the present disclosure, comprising: detecting, by the MNO device (100), change in at least one attribute of the plurality of parameters of the IOC representing the UPS related information of the MNO site; modifying, by the MNO device (100), the at least one attribute of the IOC representing the UPS related information based on the detected change; and sending, by the MNO device (100), a notification to the DSO station (200) informing about the changes to the at least one modified attribute of the IOC representing the UPS related information of MNO site based on the notification subscription control IOC.

Accoring to an embodiment of the present disclosure, wherein the plurality of notification subscription parameters comprises at least one of a notification recipient address attribute having an address of the DSO station (200), an notification types attribute having a notify MOI attribute value changes to at least one attribute of the plurality of attributes of the IOC representing the UPS related information of MNO site, and an attribute notification filter indicating a filter to be applied to candidate notifications identified by the notification types attribute.

Accoring to an embodiment of the present disclosure, comprising: receiving, by the MNO device (100), a get MOI attribute request from the DSO station (200) to retrieve at least one attribute of the plurality of attributes of the IOC representing the UPS related information of MNO site; and sending, by the MNO device (100), a get MOI attribute response comprising the at least one attribute of the IOC representing the UPS related information of MNO site to the DSO station (200).

Accoring to an embodiment of the present disclosure, a method for coordinated service recovery in a wireless network (1000), comprising: sending, by a DSO station (200), a create MOI request to a MNO device (100) for creating an IOC representing UPS related information of MNO site as child of an IOC for a DSO rapid recovery;receiving, by the DSO station (200), a create MOI response from the MNO device (100) after creation of the IOC representing the UPS related information of a MNO site comprising a plurality of attributes, wherein the IOC representing the UPS related information of the MNO site is created as child of the IOC for the DSO rapid recovery; and performing, by the DSO station (200), coordinated intelligent outage planning using the IOC representing the UPS related information of MNO site.

Accoring to an embodiment of the present disclosure, wherein the plurality of attributes of the IOC of the UPS related information of MNO site comprises: information about whether the MNO site has the UPS installed/available or not, information about a total UPS backup capacity installed in the MNO site; information about a status of remaining UPS backup capacity available for MNO site at a given time; an identity of an energy supply meter of the DSO present in the MNO site; and an identity of a base station present in the MNO site.

Accoring to an embodiment of the present disclosure, comprising: creating, by the DSO station (200), a create MOI request comprising a plurality of notification subscription parameters for the DSO station (200), wherein the plurality of notification subscription parameters comprises at least one of a notification recipient address attribute having an address of the DSO station (200), an notification types attribute having a notify MOI attribute value changes to at least one attribute of the plurality of attributes of the IOC representing the UPS related information of MNO site, and an attribute notification filter indicating a filter to be applied to candidate notifications identified by the notification types attribute; sending, by the DSO station (200), the create MOI request to the MNO device (100) for creating a notification subscription control IOC as per the plurality of notification subscription parameters; and receiving, by the DSO station (200), a create MOI response from the MNO device (100) after creation of the notification subscription control IOC by the MNO device (100).

Accoring to an embodiment of the present disclosure, comprising receiving, by the DSO station (200), a notification from the MNO device (100) informing about changes to at least one modified attribute of the plurality of attributes of the IOC representing the UPS related information of MNO site based on the notification subscription control IOC.

Accoring to an embodiment of the present disclosure, comprising: sending, by the DSO station (200), a get MOI attribute request to the MNO device (100) to retrieve at least one attribute of the plurality of attributes of the IOC representing the UPS related information of MNO site from the MNO device (100); and receiving, by the DSO station (200), a get MOI attribute response comprising the at least one attribute of the IOC representing the UPS related information of MNO site from the MNO device (100).

Accoring to an embodiment of the present disclosure, a MNO device (100) for coordinated service recovery in a wireless network (1000), comprising: a memory (130); a processor (110); and a coordinated service recovery controller (140), communicatively coupled to the memory (130) and the processor (110), configured to: receive a create MOI request from the DSO station (200), wherein the create MOI request is for creating an IOC representing UPS related information of a MNO site as child of an IOC for DSO rapid recovery; create the IOC representing the UPS related information of a MNO site comprising a plurality of attributes, wherein the IOC representing the UPS related information of the MNO site is created as child of the IOC for the DSO rapid recovery; and send a create MOI response to the DSO station (200) after creation of the IOC representing the UPS related information of the MNO site.

Accoring to an embodiment of the present disclosure, wherein the plurality of attributes of the IOC representing the UPS related information of the MNO site comprises: information about whether the MNO site has a UPS installed/available or not, information about a total UPS backup capacity installed in the MNO site; information about a status of remaining UPS backup capacity available for the MNO site at a given time; an identity of an energy supply meter of the DSO present in the MNO site; and an identity of a base station present in the MNO site.

Accoring to an embodiment of the present disclosure, wherein the coordinated service recovery controller (140) is configured to: receive a create MOI request from the DSO station (200) for creating a notification subscription control IOC to the MNO device (100), wherein the create MOI request comprises a plurality of notification subscription parameters related to the IOC representing the UPS related information of the MNO site; create the notification subscription control IOC based on the plurality of notification subscription parameters; and send a create MOI response to the DSO station (200) after creation of the notification subscription control IOC by the MNO device (100).

Accoring to an embodiment of the present disclosure, wherein the coordinated service recovery controller (140) is configured to: detect change in at least one attribute of the plurality of parameters of the IOC representing the UPS related information of the MNO site; modify the at least one attribute of the IOC representing the UPS related information based on the detected change; and send a notification to the DSO station (200) informing about the changes to the at least one modified attribute of the IOC representing the UPS related information of MNO site based on the notification subscription control IOC.

Accoring to an embodiment of the present disclosure, wherein the plurality of notification subscription parameters comprises at least one of a notification recipient address attribute having an address of the DSO station (200), an notification types attribute having a notify MOI attribute value changes to at least one attribute of the plurality of attributes of the IOC representing the UPS related information of MNO site, and an attribute notification filter indicating a filter to be applied to candidate notifications identified by the notification types attribute.

Accoring to an embodiment of the present disclosure, wherein the coordinated service recovery controller (140) is configured to: receive a get MOI attribute request from the DSO station (200) to retrieve at least one attribute of the plurality of attributes of the IOC representing the UPS related information of MNO site; and send a get MOI attribute response comprising the at least one attribute of the IOC representing the UPS related information of MNO site to the DSO station (200).

Accoring to an embodiment of the present disclosure, a DSO station (200) for coordinated service recovery in a wireless network (1000), comprising: a memory (230); a processor (210); and a coordinated service recovery controller (240), communicatively coupled to the memory (230) and the processor (210), configured to: send a create MOI request to a MNO device (100) for creating an IOC representing UPS related information of MNO site as child of an IOC for a DSO rapid recovery; receive a create MOI response from the MNO device (100) after creation of the IOC representing the UPS related information of a MNO site comprising a plurality of attributes, wherein the IOC representing the UPS related information of the MNO site is created as child of the IOC for the DSO rapid recovery; and perform coordinated intelligent outage planning using the IOC representing the UPS related information of MNO site.

Accoring to an embodiment of the present disclosure, wherein the plurality of attributes of the IOC of the UPS related information of MNO site comprises: information about whether the MNO site has the UPS installed/available or not, information about a total UPS backup capacity installed in the MNO site; information about a status of remaining UPS backup capacity available for MNO site at a given time; an identity of an energy supply meter of the DSO present in the MNO site; and an identity of a base station present in the MNO site.

Accoring to an embodiment of the present disclosure, wherein the coordinated service recovery controller (240) is configured to: create a create MOI request comprising a plurality of notification subscription parameters for the DSO station (200), wherein the plurality of notification subscription parameters comprises at least one of a notification recipient address attribute having an address of the DSO station (200), an notification types attribute having a notify MOI attribute value changes to at least one attribute of the plurality of attributes of the IOC representing the UPS related information of MNO site, and an attribute notification filter indicating a filter to be applied to candidate notifications identified by the notification types attribute; send the create MOI request to the MNO device (100) for creating a notification subscription control IOC as per the plurality of notification subscription parameters; and receive a create MOI response from the MNO device (100) after creation of the notification subscription control IOC by the MNO device (100).

Accoring to an embodiment of the present disclosure, wherein the coordinated service recovery controller (240) is configured to receive a notification from the MNO device (100) informing about changes to at least one modified attribute of the plurality of attributes of the IOC representing the UPS related information of MNO site based on the notification subscription control IOC.

Accoring to an embodiment of the present disclosure, wherein the coordinated service recovery controller (240) is configured to: send a get MOI attribute request to the MNO device (100) to retrieve at least one attribute of the plurality of attributes of the IOC representing the UPS related information of MNO site from the MNO device (100); and receive a get MOI attribute response comprising the at least one attribute of the IOC representing the UPS related information of MNO site from the MNO device (100).

FIG. 8 illustrates a structure of a UE according to an embodiment of the disclosure.

As shown in FIG. 8, the UE according to an embodiment may include a transceiver 810, a memory 820, and a processor 830. The transceiver 810, the memory 820, and the processor 830 of the UE may operate according to a communication method of the UE described above. However, the components of the UE are not limited thereto. For example, the UE may include more or fewer components than those described above. In addition, the processor 830, the transceiver 810, and the memory 820 may be implemented as a single chip. Also, the processor 830 may include at least one processor.

The transceiver 810 collectively refers to a UE receiver and a UE transmitter, and may transmit/receive a signal to/from a base station or a network entity. The signal transmitted or received to or from the base station or a network entity may include control information and data. The transceiver 810 may include a RF transmitter for upconverting and amplifying a frequency of a transmitted signal, and a RF receiver for amplifying low-noise and down-converting a frequency of a received signal. However, this is only an example of the transceiver 810 and components of the transceiver 810 are not limited to the RF transmitter and the RF receiver.

Also, the transceiver 810 may receive and output, to the processor 830, a signal through a wireless channel, and transmit a signal output from the processor 830 through the wireless channel.

The memory 820 may store a program and data required for operations of the UE. Also, the memory 820 may store control information or data included in a signal obtained by the UE. The memory 820 may be a storage medium, such as read-only memory (ROM), random access memory (RAM), a hard disk, a CD-ROM, and a DVD, or a combination of storage media.

The processor 830 may control a series of processes such that the UE operates as described above. For example, the transceiver 810 may receive a data signal including a control signal transmitted by the base station or the network entity, and the processor 830 may determine a result of receiving the control signal and the data signal transmitted by the base station or the network entity.

FIG. 9 illustrates a structure of a base station according to an embodiment of the disclosure.

As shown in FIG. 9, the base station according to an embodiment may include a transceiver 910, a memory 920, and a processor 930. The transceiver 910, the memory 920, and the processor 930 of the base station may operate according to a communication method of the base station described above. However, the components of the base station are not limited thereto. For example, the base station may include more or fewer components than those described above. In addition, the processor 930, the transceiver 910, and the memory 920 may be implemented as a single chip. Also, the processor 930 may include at least one processor.

The transceiver 910 collectively refers to a base station receiver and a base station transmitter, and may transmit/receive a signal to/from a terminal (UE) or a network entity. The signal transmitted or received to or from the terminal or a network entity may include control information and data. The transceiver 910 may include a RF transmitter for up-converting and amplifying a frequency of a transmitted signal, and a RF receiver for amplifying low-noise and down-converting a frequency of a received signal. However, this is only an example of the transceiver 910 and components of the transceiver 910 are not limited to the RF transmitter and the RF receiver.

Also, the transceiver 910 may receive and output, to the processor 930, a signal through a wireless channel, and transmit a signal output from the processor 930 through the wireless channel.

The memory 920 may store a program and data required for operations of the base station. Also, the memory 920 may store control information or data included in a signal obtained by the base station. The memory 920 may be a storage medium, such as read-only memory (ROM), random access memory (RAM), a hard disk, a CDROM, and a DVD, or a combination of storage media.

The processor 930 may control a series of processes such that the base station operates as described above. For example, the transceiver 910 may receive a data signal including a control signal transmitted by the terminal, and the processor 930 may determine a result of receiving the control signal and the data signal transmitted by the terminal.

The various actions, acts, blocks, steps, or the like in the flow charts (S600 and S700) may be performed in the order presented, in a different order or simultaneously. Further, in some embodiments, some of the actions, acts, blocks, steps, or the like may be omitted, added, modified, skipped, or the like without departing from the scope of the invention.

The foregoing description of the specific embodiments will so fully reveal the general nature of the embodiments herein that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A method performed by a first server in a mobile communication system, the method comprising:
performing, with a second server, a create managed object instance (MOI) procedure for a first information object class (IOC) associated with recovery of an energy service; and
creating a first MOI associated with uninterruptable power supply (UPS) related information of the first server, based on the create MOI procedure, wherein the UPS related information of the first server is included in the first IOC.

2. The method of claim 1, wherein the UPS related information of the first server includes first information on whether a UPS of the first server is available, second information on total UPS backup capacity of the UPS of the first server, third information on a status of remaining UPS backup capacity of the UPS of the first server, fourth information on an identity of energy supply meter for the second server present in the first server, and fifth information on an identity of a base station present in the first server.

3. The method of claim 1, further comprising:
receiving, from the second server, a create MOI request associated with creating second IOC associated with a notification of a change of the information;
creating a second MOI associated with the second IOC; and
transmitting, to the second server, a response for the create MOI request.

4. The method of claim 3, further comprising:
in case that the information is changed in the first server, transmitting, to the second server, the notification of the change of the information.

5. A first server in a mobile communication system, the first server comprising:
a transceiver; and
a controller coupled with the transceiver and configured to:
perform, with a second server, a create managed object instance (MOI) procedure for a first information object class (IOC) associated with recovery of an energy service, and
create a first MOI associated with uninterruptable power supply (UPS) related information of the first server, based on the create MOI procedure, wherein the UPS related information of the first server is included in the first IOC.

6. The first server of claim 5, wherein the UPS related information of the first server includes first information on whether a UPS of the first server is available, second information on total UPS backup capacity of the UPS of the first server, third information on a status of remaining UPS backup capacity of the UPS of the first server, fourth information on an identity of energy supply meter for the second server present in the first server, and fifth information on an identity of a base station present in the first server.

7. The first server of claim 5, wherein the controller is further configured to:
receive, from the second server, a create MOI request associated with creating second IOC associated with a notification of a change of the information,
creating a second MOI associated with the second IOC, and
transmit, to the second server, a response for the create MOI request.

8. The first server of claim 7, wherein the controller is further configured to:
in case that the information is changed in the first server, transmit, to the second server, the notification of the change of the information.

9. A method performed by a second server in a mobile communication system, the method comprising:
performing, with a first server, a create managed object instance (MOI) procedure for a first information object class (IOC) associated with recovery of an energy service,
wherein a first MOI associated with uninterruptable power supply (UPS) related information of the first server is created based on the create MOI procedure, and
wherein the UPS related information of the first server is included in the first IOC.

10. The method of claim 9, wherein the UPS related information of the first server includes first information on whether a UPS of the first server is available, second information on total UPS backup capacity of the UPS of the first server, third information on a status of remaining UPS backup capacity of the UPS of the first server, fourth information on an identity of energy supply meter for the second server present in the first server, and fifth information on an identity of a base station present in the first server.

11. The method of claim 9, further comprising:
transmitting, to the first server, a create MOI request associated with creating second IOC associated with a notification of a change of the information, a second MOI associated with the second IOC is created; and
receiving, from the first server, a response for the create MOI request.

12. The method of claim 11, further comprising:
in case that the information is changed in the first server, receiving, from the first server, the notification of the change of the information.

13. A second server in a mobile communication system, the second server comprising:
a transceiver; and
a controller coupled with the transceiver and configured to:
perform, with a first server, a create managed object instance (MOI) procedure for a first information object class (IOC) associated with recovery of an energy service,
wherein a first MOI associated with uninterruptable power supply (UPS) related information of the first server is created based on the create MOI procedure, and
wherein the UPS related information of the first server is included in the first IOC.

14. The second server of claim 13, wherein the UPS related information of the first server includes first information on whether a UPS of the first server is available, second information on total UPS backup capacity of the UPS of the first server, third information on a status of remaining UPS backup capacity of the UPS of the first server, fourth information on an identity of energy supply meter for the second server present in the first server, and fifth information on an identity of a base station present in the first server.

15. The second server of claim 9, wherein the controller is further configured to:
transmit, to the first server, a create MOI request associated with creating second IOC associated with a notification of a change of the information, a second MOI associated with the second IOC is created, and
receive, from the first server, a response for the create MOI request.
